(19) United States
(12) Patent Application Publication
(10) Pub. No.: US 2012/0146937 A1
(43) Pub. Date: Jun. 14, 2012

(54) CAPACITIVE TOUCH PANEL

(76) Inventor: Jane HSU, Taoyuan County (TW)

(21) Appl. No.: 13/240,666

(22) Filed: Sep. 22, 2011

(30) Foreign Application Priority Data
Dec. 14, 2010 (TW) 099224201

(51) Int. Cl. G06F 3/045

(52) U.S. Cl. 345/174

(57) ABSTRACT

A capacitive touch panel has an. X-axis sensing layer and a Y-axis sensing layer. The X-axis and Y-axis sensing layers respectively have multiple sensing rows and sensing columns. Each sensing row or sensing column has multiple X-axis or Y-axis electrode strings. Each X-axis or Y-axis electrode string has multiple X-axis electrodes or Y-axis electrodes serially connected. The X-axis electrode strings or Y-axis electrode strings are connected in parallel with each other. The Y-axis electrodes are alternately or directly aligned with the X-axis electrodes. With the foregoing design, the resistance of each row and column can be effectively reduced so as to raise the reading sensitivity of a controller and maintain uniform internal resistance for each sensing row and column to facilitate enlargement of the capacitive touch panel.

### BACKGROUND OF THE INVENTION

1. Field of the Invention

The present invention relates to a capacitive touch panel, and more particularly to a projected capacitive touch panel having lower and uniform values of internal resistance of the electrodes on the sensing layers.

2. Description of the Related Art

With reference to FIG. 4, a conventional projected capacitive touch panel has a substrate 70, an X-axis sensing layer 80 and a Y-axis sensing layer 90. The substrate 70 is transparent. The X-axis sensing layer 80 is formed on a top surface of the substrate 70 and has multiple horizontal sensing rows. Each sensing row has multiple rhombic X-axis electrodes 81 serially connected to each other and is connected with an X-axis driving line 82.

The Y-axis sensing layer 90 is formed on a bottom surface of the substrate 70 and has multiple vertical sensing columns. Each sensing column has multiple rhombic Y-axis electrodes 91 serially connected to each other and is connected with a Y-axis driving line 92.

The Y-axis electrodes 91 of the Y-axis sensing layer 90 and the respective X-axis electrodes 81 of the X-axis sensing layer 80 are alternately or directly aligned with each other. With reference to FIG. 5, when the Y-axis electrodes 91 and the respective X-axis electrodes 81 are alternately aligned with each other, the projected capacitive touch panel is a self capacitance touch panel. When the Y-axis electrodes 91 and the respective X-axis electrodes 81 are directly aligned with each other, the projected capacitive touch panel is a mutual capacitance touch panel.

The X-axis driving lines and the Y-axis driving lines on the X-axis sensing layer 80 and the Y-axis sensing layer 90 are connected to a controller for the controller to detect capacitance variation of each capacitive node on the X-axis sensing layer 80 and the Y-axis sensing layer 90. Projected capacitive touch panels are demanding concerning the coordination between the sensing layers (X-axis and Y-axis sensing layers) and the controller. As far as the X-axis driving lines 82 and the Y-axis driving lines are concerned, the magnitude of the resistance of each driving line and uniformity of the values of internal resistance of the driving lines are critical because those factors directly affect the signal to noise ratio (S/N) of the output of touch panels.

The X-axis driving lines 82 are collectively formed on one side of the X-axis sensing layer, and the Y-axis driving lines 92 are collectively formed on one side of the Y-axis sensing layer to connect with the controller. Under the circumstance, the lengths from the X-axis driving lines and from the Y-axis driving lines to the controller are not the same. As the magnitude of the resistance of each of the X-axis driving lines 82 and the Y-axis driving lines 92 is proportional to the length thereof, the larger a touch panel is, the longer the driving lines are and the greater the resistance values of the driving lines are. Hence, the sensitivity of the controller in reading touched positions is affected and consequential errors in determining touch positions may happen. On the other hand, the larger the touch panel is, the longer the X-axis driving lines and the Y-axis driving lines respectively connected to the sensing rows and the sensing columns adjacent to respective edges of the touch panel are. Therefore, the values of internal resistance of the sensing rows and the sensing columns are not uniform such that not only sensitivity of the controller in determining touched positions but also enlargement of touch panel is affected.

### SUMMARY OF THE INVENTION

An objective of the present invention is to provide a projected capacitive touch panel having lower and uniform values of internal resistance of the electrodes on the sensing layers to raise sensitivity of a controller in reading capacitance variation and facilitate enlargement of the touch panel.

To achieve the foregoing objective, the projected capacitive touch panel has an X-axis sensing layer and a Y-axis sensing layer.

The X-axis sensing layer has multiple sensing rows. Each sensing row has an X-axis driving line and multiple X-axis electrode strings. The X-axis driving line is formed on one end of the sensing row. The X-axis electrode strings are connected in parallel with each other. Each X-axis electrode string has multiple X-axis electrodes serially connected. The X-axis electrode of each X-axis electrode string in each sensing row adjacent to a corresponding X-axis driving line is connected to the X-axis driving line, and a selected one of the X-axis electrodes not directly connected to the X-axis driving line of the X-axis electrode string in the sensing row is connected to a selected one of the X-axis electrodes not directly connected to the X-axis driving line of each adjacent X-axis electrode string of the sensing row.

The Y-axis sensing layer has multiple sensing columns. Each sensing column has a Y-axis driving line and multiple Y-axis electrode strings.

The Y-axis driving line is formed on one end of the sensing column. The Y-axis electrode strings are connected in parallel with each other. Each Y-axis electrode string has multiple Y-axis electrodes serially connected. The Y-axis electrode of each Y-axis electrode string in each sensing column adjacent to a corresponding Y-axis driving line is connected to the Y-axis driving line, and a selected one of the Y-axis electrodes not directly connected to the Y-axis driving line of the Y-axis electrode string in the sensing column is connected to a selected one of the Y-axis electrodes not directly connected to the Y-axis driving line of each adjacent Y-axis electrode string of the sensing column, and a capacitor is formed between each Y-axis electrode and one of the X-axis electrodes.

As each sensing row of the X-axis sensing layer and each sensing column of the Y-axis sensing layer has multiple electrode strings parallelly connected with each other, the internal resistance of the parallelly connected electrode strings is lowered. Additionally, different numbers of X-axis electrodes and Y-axis electrodes of each row and each column can be selectively connected in parallel with each other to obtain different resistance values and adjust the values of internal resistance of each sensing row and each sensing column. Accordingly, each sensing row and each sensing column can have uniform internal resistance to facilitate enlargement of the touch panel.

Other objectives, advantages and novel features of the invention will become more apparent from the following detailed description when taken in conjunction with the accompanying drawings.

### BRIEF DESCRIPTION OF THE DRAWINGS

FIG. 1 is an exploded perspective view of a capacitive touch panel in accordance with the present invention;

FIG. 2A is a top view of an X-axis sensing layer of the capacitive touch panel in FIG. 1;

FIG. 2B is a bottom view of a Y-axis sensing layer of the capacitive touch panel in FIG. 1;

FIG. 3 is a top view of the X-axis sensing layer in FIG. 2A and the Y-axis sensing layer overlapping each other;

FIG. 4 is an exploded perspective view of a conventional projected capacitive touch panel; and

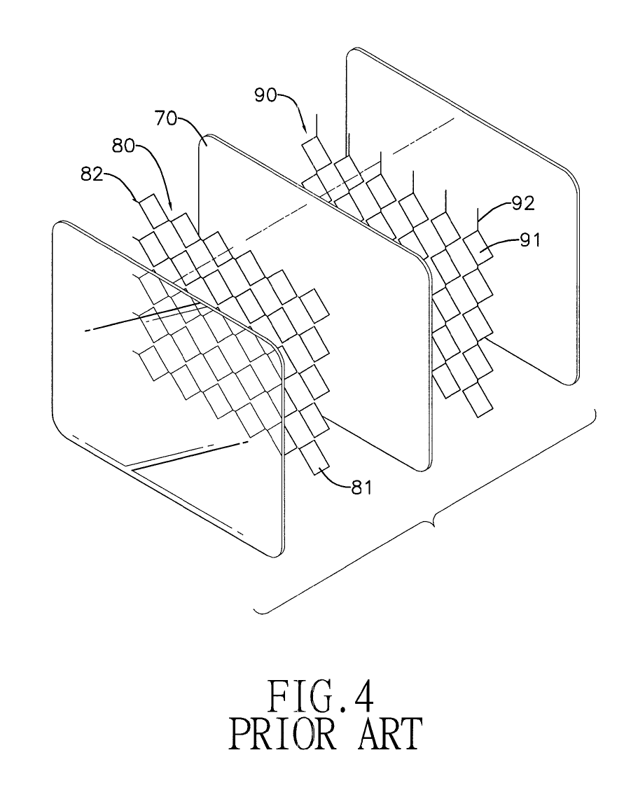

FIG. 5 is a top view of an X-axis sensing layer and a Y-axis sensing layer of the conventional projected capacitive touch panel overlapping each other in FIG. 4.

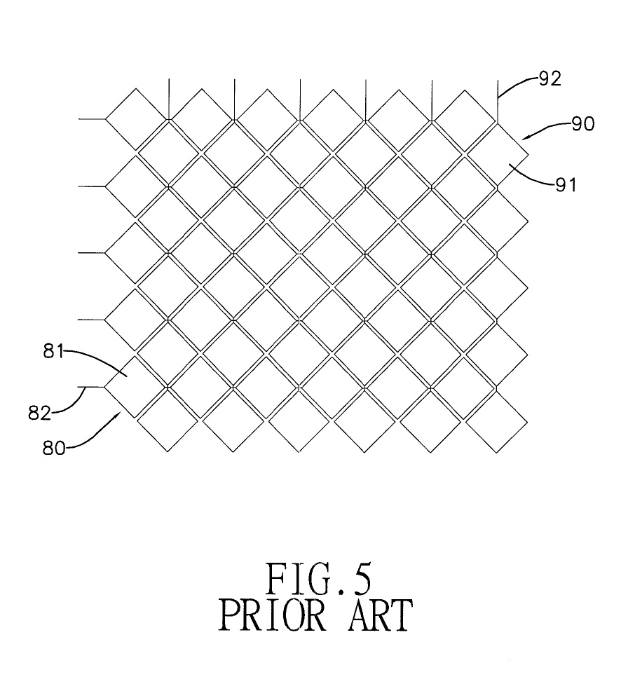

### DETAILED DESCRIPTION OF THE INVENTION

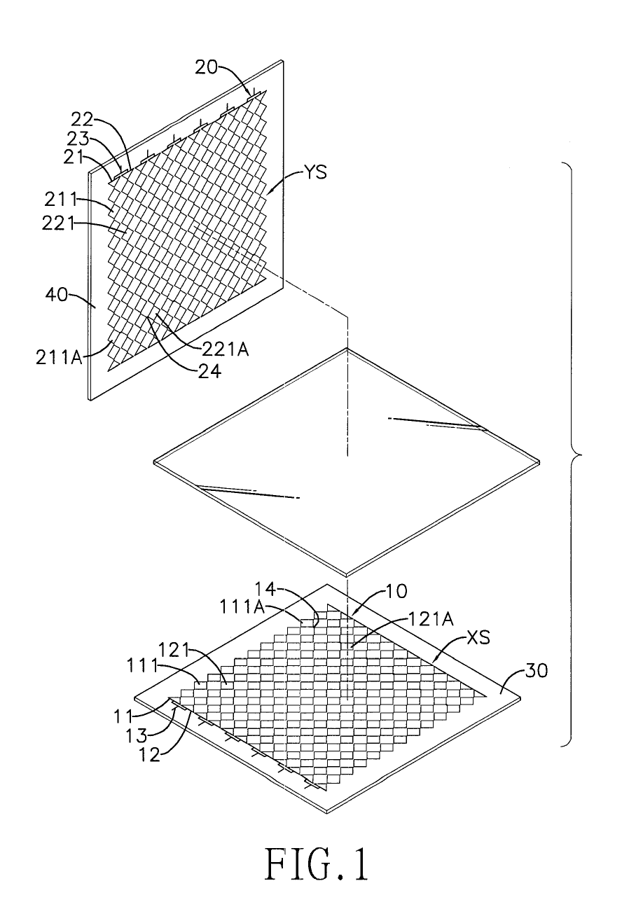

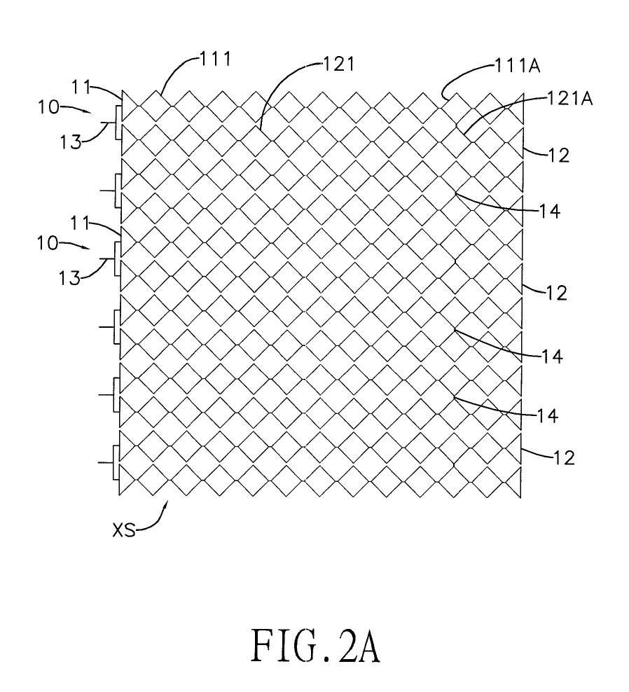

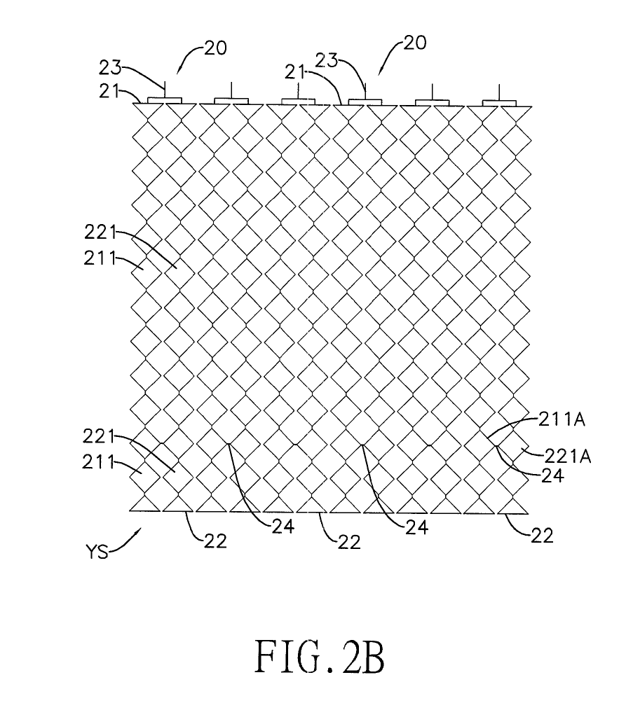

With reference to FIGS. 1, 2A and 2B, a projected capacitive touch panel in accordance with the present invention has an X-axis sensing layer XS and a Y-axis sensing layer YS.

The X-axis sensing layer XS has multiple sensing rows 10. Each sensing row 10 has an X-axis driving line 13 and multiple X-axis electrode strings 11, 12. The X-axis driving line 13 is formed on one end of the sensing row 10. In the present embodiment, each sensing row 10 includes, but not limited to, two X-axis electrode strings 11, 12. Each X-axis electrode string 11, 12 is composed of multiple X-axis electrodes 111, 121 serially connected. The two X-axis electrode strings 11, 12 have two respective X-axis electrodes 111, 121 parallelly connected. In the present embodiment, two ends of the respective X-axis electrode strings 11, 12 on a same side (left side) are parallelly connected and further connected to a corresponding X-axis driving line 13. Two adjacent X-axis electrodes 111A, 121A of the respective X-axis electrode strings 11, 12 on the opposite side (right side) are connected through an electrical connection portion 14. Under the circumstance, all X-axis electrodes 111, 111A between the corresponding X-axis driving line 13 and the connected X-axis electrode 111A of one of the two X-axis electrode strings 11 and all X-axis electrodes 121, 121A between the corresponding X-axis driving line 13 and the connected X-axis electrode 121A of the other X-axis electrode string 12 are parallelly connected. The value of resistance of the entire parallelly connected X-axis electrodes 121 varies with the total number of the X:-axis electrodes 111 parallelly connected.

The Y-axis sensing layer YS has multiple sensing columns 20. Each sensing column 20 has a Y-axis driving line 23 and multiple Y-axis electrode strings 21, 22. The Y-axis driving line 23 is formed on one end of the sensing column 20. In the present embodiment, each sensing column 20 includes, but not limited to, two Y-axis electrode strings 21, 22. Each Y-axis electrode string 21, 22 is composed of multiple Y-axis electrodes 211, 221 serially connected. The two Y-axis electrode strings 21, 22 have two respective Y-axis electrodes 211, 221 parallelly connected. In the present embodiment, two ends of the respective Y-axis electrode strings 21, 22 on a same side (top side) are parallelly connected and further connected to a corresponding Y-axis driving line 23. Two adjacent X-axis electrodes 211A, 221A of the respective X-axis electrode strings 21, 22 on the opposite side (bottom side) are connected through an electrical connection portion 24. Under the circumstance, all Y-axis electrodes 211, 211A between the corresponding Y-axis driving line 23 arid the connected Y-axis electrode 211A of one of the two Y-axis electrode strings 21 and all Y-axis electrodes 221, 221A between the corresponding Y-axis driving line 23 and the connected Y-axis electrode 221A of the other Y-axis electrode string 22 are parallelly connected. The value of resistance of the entire parallelly connected Y-axis electrodes 221 varies with the total number of the Y-axis electrodes 211 parallelly connected. A capacitor is formed between each Y-axis electrode 211 and one of the X-axis electrodes 111.

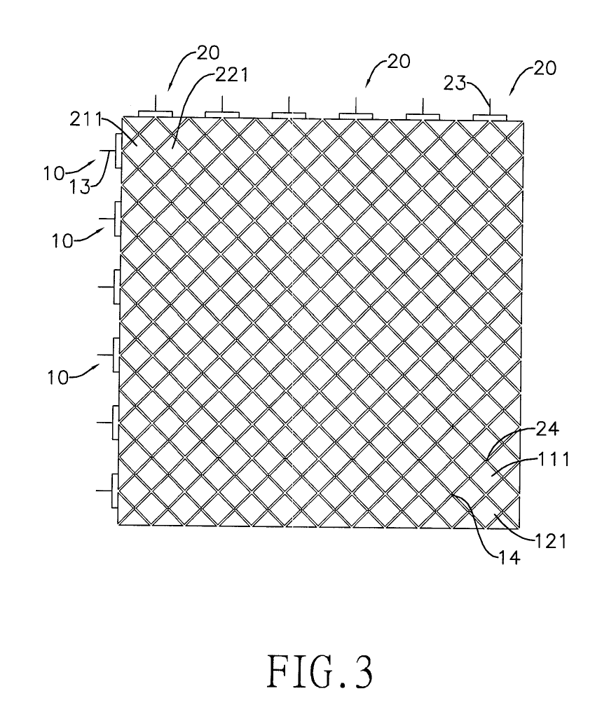

With reference to FIG. 3, the foregoing X-axis sensing layer XS and Y-axis sensing layer YS can be simultaneously formed on one surface of a substrate, and the X-axis electrodes 111, 121 of the X-axis sensing layer XS and the Y-axis electrodes 211, 221 are alternately arranged to constitute a self capacitance projected capacitive touch panel. With further reference to FIG. 1, the X-axis sensing layer XS and the Y-axis sensing layer YS are respectively formed on two opposite substrates 30, 40. Except that those on both ends of the sensing rows and the sensing columns are triangular, the X-axis electrodes 111, 121 and the Y-axis electrodes 211, 221 are rhombic. Besides, the X-axis sensing layer XS and the Y-axis sensing layer YS can be formed on two opposite surfaces of one substrate or two opposite surfaces of two substrates to constitute different types of self capacitance projected capacitive touch panels.

In addition to the self capacitance projected capacitive touch panels, the present invention is also applicable to mutual capacitance projected capacitive touch panels. One embodiment of the mutual capacitance projected capacitive touch panels has the X-axis sensing layer XS formed on a top surface of one substrate, and the Y-axis sensing layer formed on a bottom surface of the same substrate. The Y-axis electrodes 211, 221 of the Y-axis sensing layer YS are directly aligned with the X-axis electrodes 111, 121 of the X-axis sensing layer XS to constitute a mutual capacitance projected capacitive touch panel. The X-axis sensing layer XS and the Y-axis sensing layer YS can be respectively formed on two opposite surfaces of two substrates to constitute another type of mutual capacitance projected capacitive touch panel. Besides being triangular and rhombic, the X-axis electrodes 111, 121 and the Y-axis electrodes 211, 221 may be rectangular.

The two X-axis electrode strings 11, 12 of each sensing row 10 on the X-axis sensing layer XS are parallelly connected to each other. Based on parallel resistance formula, the resistance value of two parallelly connected resistors is less than the resistance value of each parallelly connected resistor (if the resistance values of the two resistors are different, the resistance value of the parallelly connected resistors is less than the resistance value of the parallelly connected resistor having a lower resistance value). As the X-axis electrode strings 11, 12 are composed of indium tin oxide (ITO) and have internal resistance, the resistance value of each sensing row is reduced as the two X-axis electrode strings 11, 12 are parallelly connected to each other. Similarly, as the two Y-axis electrode strings 21, 22 of each sensing column 20 on the Y-axis sensing layer YS are parallelly connected to each other, the resistance value of each sensing column is also reduced. Given the reduced resistance values of the sensing rows and sensing columns, sensitivity of the controller in determining touch positions can be enhanced.

As mentioned, regardless of if the X-axis sensing layer XS and the Y-axis sensing layer YS are formed on one surface or two opposite surfaces of one substrate, or two opposite surfaces of two substrates, the X-axis driving lines 13 and the Y-axis driving lines 23 respectively connected to the sensing rows 10 and the sensing columns 20 must be further implemented. The larger the size of the touch panel is, the longer the lengths of the X-axis driving lines 13 and the Y-axis driving lines 23 adjacent to the respective edges of the touch panel are, or the longer the distances from the X-axis driving lines 13 and from the Y-axis driving lines 23 adjacent to the respective edges of the touch panel to the controller are. As a result, the wire resistance of those X-axis driving lines 13 and Y-axis driving lines 23 adjacent to the respective edges of the touch panel are relatively high. Meanwhile, the internal resistance values of the sensing rows 10 and the sensing columns are not uniform. By parallelly connecting multiple X-axis electrodes 111, 121 of the respective X-axis electrode strings 11, 12 of each sensing row 10, the internal resistance value of the sensing row 10 varies with the total number of the X-axis electrodes 111, 121 of the sensing row 10 parallely connected to each other. By parallelly connecting multiple Y-axis electrodes 211, 221 of the respective Y-axis electrode strings 21, 22 of each sensing column 20, the internal resistance value of the sensing column 20 varies with the total number of the Y-axis electrodes 211, 221 of the sensing column 20 parallely connected to each other. Consequently, the internal resistance values of each sensing row and sensing column can be adjusted depending on the lengths of the corresponding X-axis driving line arid Y-axis driving line or the distances from the corresponding X-axis driving line and from Y-axis driving line to the controller, thereby not only lowering the internal resistance value of each sensing row or sensing column but also enhancing accuracy of the controller in determining touched positions to facilitate enlargement of the touch panels.

Even though numerous characteristics and advantages of the present invention have been set forth in the foregoing description, together with details of the structure and function of the invention, the disclosure is illustrative only. Changes may be made in detail, especially in matters of shape, size, and arrangement of parts within the principles of the invention to the full extent indicated by the broad general meaning of the terms in which the appended claims are expressed.

What is claimed is:

1. A capacitive touch panel comprising:
an X-axis sensing layer having multiple sensing rows, wherein each sensing row has:
an X-axis driving line formed on one end of the sensing row; and
multiple X-axis electrode strings connected in parallel with each other,
wherein each X-axis electrode string has multiple X-axis electrodes serially connected, and the X-axis electrode of each X-axis electrode string in each sensing row adjacent to a corresponding X-axis driving line is connected to the X-axis driving line, and a selected one of the X-axis electrodes not directly connected to the X-axis driving line of the X-axis electrode string in the sensing row is connected to a selected one of the X-axis electrodes not directly connected to the X-axis driving line of each adjacent X-axis electrode string of the sensing row; and
a Y-axis sensing layer having multiple sensing columns, wherein each sensing column has:
a Y-axis driving line formed on one end of the sensing column; and
multiple Y-axis electrode strings connected in parallel with each other, wherein each Y-axis electrode string has multiple Y-axis electrodes serially connected, the Y-axis electrode of each Y-axis electrode string in each sensing column adjacent to a corresponding Y-axis driving line is connected to the Y-axis driving line, and a selected one of the Y-axis electrodes not directly connected to the Y-axis driving line of the Y-axis electrode string in the sensing column is connected to a selected one of the Y-axis electrodes not directly connected to the Y-axis driving line of each adjacent Y-axis electrode string of the sensing column, and a capacitor is formed between each Y-axis electrode and one of the X-axis electrodes.

2. The capacitive touch panel as claimed in claim 1, wherein the X-axis electrodes of the X-axis sensing layer are alternately aligned with the Y-axis electrodes of the Y-axis sensing layer to constitute a self capacitance projected capacitance touch panel.

3. The capacitive touch panel as claimed in claim 1, wherein the X-axis electrodes of the X-axis sensing layer are directly aligned with the Y-axis electrodes of the Y-axis sensing layer to constitute a mutual capacitance projected capacitance touch panel.

4. The capacitive touch panel as claimed in claim 2, wherein the X-axis sensing layer and the Y-axis sensing layer are simultaneously formed on one surface of a substrate.

5. The capacitive touch panel as claimed in claim 2, wherein the X-axis sensing layer and the Y-axis sensing layer are respectively formed on two opposite surfaces of two substrates.

6. The capacitive touch panel as claimed in claim 3, wherein the X-axis sensing layer and the Y-axis sensing layer are respectively formed on two opposite surfaces of two substrates.

7. The capacitive touch panel as claimed in claim 2, wherein the X-axis sensing layer and the Y-axis sensing layer are respectively formed on two opposite surfaces of a substrate.

8. The capacitive touch panel as claimed in claim 3, wherein the X-axis sensing layer and the Y-axis sensing layer are respectively formed on two opposite surfaces of a substrate.

9. The capacitive touch panel as claimed in claim 2, wherein each X-axis electrode of the X-axis sensing layer and each Y-axis electrode of the Y-axis sensing layer are rhombic.

10. The capacitive touch panel as claimed in claim 3, wherein each X-axis electrode of the X-axis sensing layer and each Y-axis electrode of the Y-axis sensing layer are rhombic.

11. The capacitive touch panel as claimed in claim 3, wherein each X-axis electrode of the X-axis sensing layer and each Y-axis electrode of the Y-axis sensing layer are rectangular.
